(19) United States
(12) Patent Application Publication
(10) Pub. No.: US 2004/0185797 A1
(43) Pub. Date: Sep. 23, 2004

(54) Arrangement of device modules and method for the production thereof

(76) Inventor: Manfred Tasto, Bocholt (DE)

Correspondence Address: BELL, BOYD & LLOYD, LLC, P. O. BOX 1135, CHICAGO, IL, 60690-1135, US

(21) Appl. No.: 10/484,999

(22) PCT Filed: Jul. 10, 2002
(86) PCT No.: PCT/DE02/02528

(30) Foreign Application Priority Data
Jul. 25, 2001 (DE) 101 36 214.5

(51) Int. Cl. H04B 1/38

(52) U.S. Cl. 455/90.3

(57) ABSTRACT

According to the invention, the functional units of a complex and high quality overall system are distributed in system modules in such a manner that the total accrued license payments to external rights holders are minimized. According to the invention, price increasing resources are used, preferably in system modules where the license charges are reduced or low.

Mobile radio products, especially those of recent generations, are burdened with significant costs by high license fee demands from various owners of protected rights. These license cost are normally measured as percentage values of the sale price of the product; they are oriented towards the communication standards (e.g. GSM, IS95-CDMA, etc.), with which the product concerned is compatible.

One result of this process is that frequently proportional license costs are paid for parts of the product, (e.g. for the battery, the display, etc.) that have nothing to do with a communication standard. It can even occur that with multi-mode mobile radio devices—i.e. for devices that are simultaneously compatible with more than one communication standard (e.g. with DECT and GSM)—the modules are not subject to standards for which licenses are required but are still burdened with the costs of the standards for which licenses are required since they are a component of the product.

The underlying object of the present invention is thus to use technical means to keep the license costs of information and/or communication technology devices, for example of mobile radio devices, as low as possible.

This object is achieved by devices or methods in accordance with one of the patent claims.

The invention is explained in more detail below using preferred exemplary embodiments and with the aid of Figures.

In accordance with the present invention an arrangement of device modules (GM1) is provided which implements functional features of a device minimized from the cost standpoint. Using suitable mechanical or information technology interfaces (IF) a second or even further device modules (GM2, . . . ,GMn) can be linked to each other or to the first device module, with these second or further device modules implementing functional expansions of the first device module.

The first device module could for example be a minimal mobile telephone that could have the following features:

It operates in accordance with one (e.g. UMTS) or more (e.g. UMTS and GSM) mobile radio standards.

The minimal mobile telephone merely has a capability for being switched on and off; otherwise it is lacking in any other operating option, in particular a possibility of “dialing in”, i.e. for entry or selection of telephone numbers etc., or a display. When it is switched on only one prespecified telephone number is dialed, e.g. an emergency services number.

It has an interface which can be used to enable the minimal telephone to be connected to another device, combined with it or linked to it. This device can for example be a Personal Digital Assistant (PDA) or a computer (notebook, laptop). The minimal telephone can be controlled or operated from this device or through it so that it can realize all the functions of a functionally higher-quality mobile telephone, e.g. Entry or selection of a dialing information for any subscriber number to be dialed, handling of incoming calls, checking of authorizations, display of operating states, etc.

A minimal telephone of this type fulfills the conditions laid down by most license agreements for being a “telephone”. As a result license fees are only payable for this device module. Since this device module is optimized from the cost standpoint, i.e. has minimal functions, its manufacturing costs are minimal.

It is thus possible to retail this device module at minimal prices. The manufacturer and sales turnover with this first device module, in comparison to conventional information and communication technology devices, for example mobile radio devices equipped with full or comprehensive functionality, will thus be very small. As a result it is to be expected that the license fees to be paid will be correspondingly small or even significantly lower than if, instead of the functionally minimized device module, a functionally comprehensive complete device were to form the basis for charging the license fees.

In accordance with an advantageous embodiment of the present invention a mechanical interface is provided which enables the device modules to be combined into a compact, easy-to-operate device.

To this end, the modules are preferably arranged in their mechanical layout enabling them to be combined with other modules so that's the overall device, that is the united modules, is compact and easy to handle.

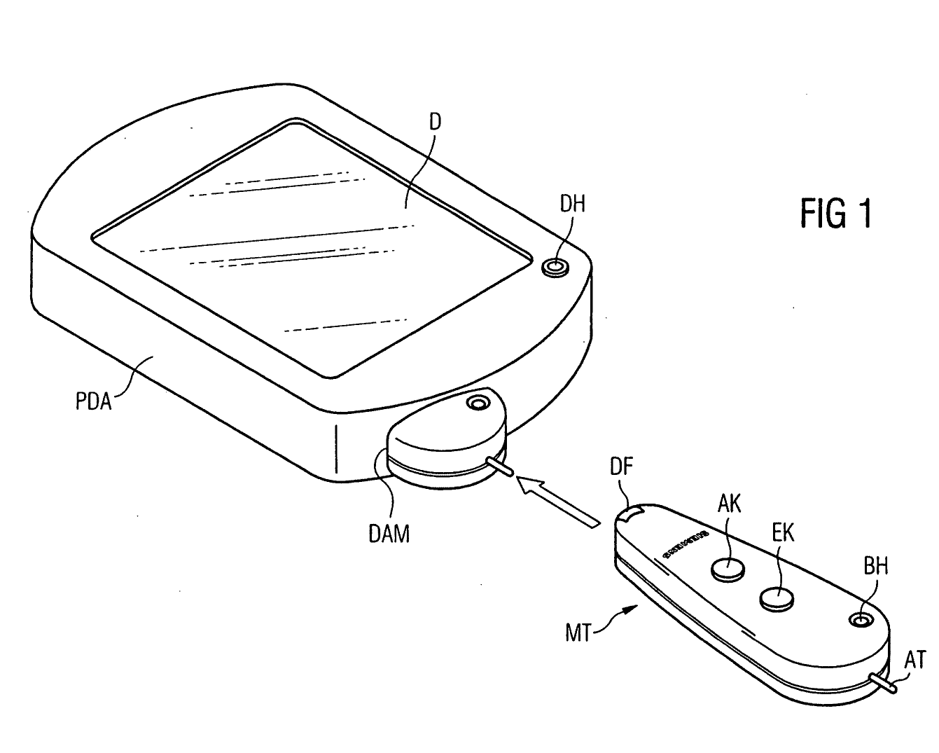

FIG. 1 shows a block schematic illustrating an advantageous exemplary embodiment of the arrangement of device modules in accordance with invention.

The first device module (GM1 or MT), a minimal telephone, has controls (EK, AK) for switching it on and off, an antenna (AT) and possibly a jack socket (BH) for a head set. In addition a facility for connecting (DF) this first device module to a second device module (GM2 or PDA) which is a PDA for example, is provided. The PDA has a display (D) and possibly a separate jack socket (DH) for connecting a head set (H) which is needed when the PDA is to be operated without the first device module (minimal telephone). The PDA also has a mechanical interface (DAM) for connecting it to the first device module which in this example is designed as an opening to accept the minimal telephone in the housing of the PDA.

In this opening there is electronic or optoelectronic or communication technology equipment which forms an information technology interface to connect the PDA to the minimal telephone.

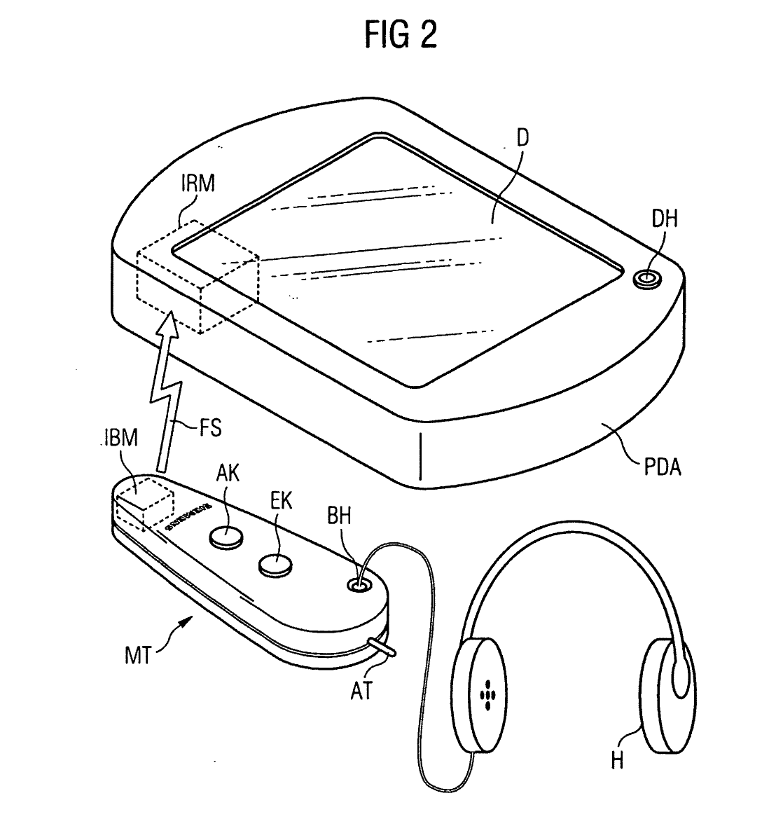

As shown schematically in FIG. 2, the interface between the device modules can also be of a purely information technology nature and for example be designed as a—preferably short-range—radio interface (FS) between the device modules. The familiar Bluetooth technology its suitable for this for example, as are many other standards, protocols and technologies known to a person skilled in the art (e.g. DECT, Home RF, etc.) for establishing (short-range) radio interfaces. To this end a facility (IBM, IRM) for wireless transmission of information is provided. Naturally other wireless technologies, such as infra-red transmission, magnetic induction etc. can be used. With this solution (exemplary embodiment) a physical (mechanical) integration of the device modules is dispensed with. The device modules will simply be integrated into an overall unit by establishing an adequate physical proximity between them.

in accordance with a further advantageous exemplary embodiment of the invention, at least one device module is an autonomous marketable product. What this measure achieves is that the price of the smallest marketable unit is not unnecessarily increased by

the fact that this smallest marketable unit comprises more than one device module.

In accordance with a further advantageous exemplary embodiment the information technology interface for transmission of control information, status information and/or dialing information is created between the device modules. By connecting device modules in different ways, numbers and configurations with different features and functional equipment such as controls, input/output facilities, memory facilities, radio transmission facilities, etc. this measure allows the user to construct a device that is tailored to his needs in the optimum way, that implements the functional scope needed in each case and can therefore be manufactured at the minimum cost.

If a device module makes use of the object of a protected right for the use of which license fees are to be paid to the owner of the protected right, only the turnover of the device manufacturer with this device module is to be used as a basis for calculating the license payments to be made. This reduces the individual license payments and thereby the overall license burden of each arrangement of device modules compared to conventional devices with the same performance and the same scope of functions.

In accordance with further advantageous embodiments of the invention the SIM (SIM=Subscriber Identity Module) card is not necessarily accommodated in the first device module (minimal telephone) but instead can be integrated into one of the other modules or accommodated so that it is removable, for example if it is not required by the minimal telephone that its user must be able to be called by external parties.

A processor that could greatly increase the costs of the device with product features subject to license payments, is advantageously integrated into a device module where possible featuring no unprotected features or as few as possible, to minimize the costs of device modules subject to license payments. Since the mobile telephone module must be regularly compatible with at least one telecommunications standard of which the pre-specified features are frequently protected by patents or other protected rights, it will be advantageous in many cases not to integrate components such as processors and similar equipment that increase the costs into the mobile telephone module but to relocate this equipment into other device modules that are free from license payments as far as possible.

Regardless of the device module in which the processor or other resources are accommodated, if the information technology interface between the device modules is designed in an appropriate way, this equipment can be used simultaneously by all the device modules provided the interface is only suitable and arranged for transmissions of the corresponding information and commands between the device modules.

Then for example the processor accommodated in one a device module can use suitable software to control other device modules such that the arrangement of connected devices fulfills the function of a high quality mobile radio terminal overall.

The further modules can be physically (mechanically) arranged so that they can be accommodated in the housing of the minimal telephone. Conversely however the minimal telephone can also be a model that can be accommodated in the housing of another device module—as shown in FIG. 1.

In other cases a number of radio modules compatible with different mobile radio or other communication standards (minimal telephones) can be connected to another device or physically integrated into the housing of this device in such a way as to produce a multi-mode mobile radio telephone. The integrating device could for example provide a common operating interface, input/output facilities and a common power supply which is more powerful than the individual power supplies of the minimal mobile telephones minimized in accordance with cost considerations.

Thus for example a PDA with a high quality battery or a high quality, very powerful rechargeable battery, with a high quality display and high quality input options could be expanded via an interface in accordance with invention which is mechanically designed as an opening in the housing in which a minimal telephone or a number of minimal telephones can be inserted to make it into a high quality mobile telephone. By connecting or inserting the device module into the interfaces the power supply of the only rudimentarily supplied device modules can be switched over to the high quality power supply of the PDA.

Naturally all the embodiments featured in this description of the invention can also be advantageously combined with each other.

The examples illustrated here make it clear to a person skilled in the art that the invention can be realized in a large number of further ways. The basic idea behind the invention of the dividing up the functional units of a complex and high quality overall system into system modules in such a way as to minimize the license payments due to external owners of protected rights by preferably accommodating the resources that increase the price in device modules with negligible or low license payments can be used with all of these embodiments of the present invention—perhaps not mentioned explicitly here for reasons of clarity but easily found by the experts on the basis of the explanations above.

1. Arrangement of device modules with
a) a first device module (GM1) that implements the functional features of a functionally minimized device from the cost standpoint;
b) a second device module (GM2) or also further device modules (GM3, . . . ,GMn), that implement functional expansions of the first device module,
with these device modules being able to be connected to each other via suitable mechanical and/or information technology interfaces (IF).

2.) Arrangement of device modules in accordance with claim 1. in which a mechanical interface is provided which allows the device modules to be combined into a compact, easy-to-operate device.

3.) Arrangement of device modules according to one of the previous claims, in which at least one device module represents a product that could be marketed in its own right that can also be operated without operating the other modules.

4.) Arrangement of device modules according to one of the previous claims, in which an information technology interface is provided via which control information, status information and/or dial information can be transmitted.

5.) Method for manufacturing or selling devices in which device modules are manufactured or sold, with
a) a first device module (GM1) realizing functional features of a device which is functionally minimized from the cost standpoint;
b) a second device module (GM2) or also further device modules (GM3, . . . ,GMn) implementing functional expansions of the first device module, with these device modules being able to be connected to one another through suitable mechanical and/or information technology interfaces (IF).

6.) Method for manufacturing or for marketing information technology and or communication technology systems, in which the functional units of a complex and high quality overall system is divided up into system modules in such a way that the total license payments due to external holders of protected rights can be minimized preferably by accommodating resources which increase the price in system modules with negligible or low at license payments.
